(19) United States
(12) Patent Application Publication
(10) Pub. No.: US 2012/0063129 A1
(43) Pub. Date: Mar. 15, 2012

(54) LAMP DESIGNED TO USE SOLID-STATE LIGHT EMITTING DEVICE AS LIGHT SOURCE

(76) Inventors: Hiroki Nakagawa, Osaka (JP); Yoshinori Kakuno, Osaka (JP); Takaari Uemoto, Osaka (JP); Kazushige Sugita, Hyogo (JP)

(21) Appl. No.: 13/319,993

(22) PCT Filed: Mar. 2, 2011
(86) PCT No.: PCT/JP2011/001209

§ 371 Date: Nov. 10, 2011

(30) Foreign Application Priority Data
Mar. 26, 2010 (JP) 2010-073460

(51) Int. Cl. F21V 7/00; F21V 29/00; F21V 21/00

(52) U.S. Cl. 362/230; 362/249.01

(57) ABSTRACT

Provided is a lamp designed to use as a light source a solid-state light emitting device with a simple and inexpensive structure and having an improved heat dissipation performance. A lamp uses a solid-state light emitting device as a light source. A cap is mounted to an external apparatus at the time of use. A housing is made of a translucent material and is connected to the cap. A light-emitting module includes one or a plurality of solid-state light emitting devices and is mounted such that the main-light-emission side (lower side in FIG. 1) thereof is in close contact with the inner wall of the housing. Further, the gap between the housing and the light-emitting module may be filled with a thermal conductive material having a translucency and a thermal conductivity.

### TECHNICAL FIELD

The present invention relates to lamps designed to use solid-state light emitting devices such as LED and EL as light sources, and more particularly, to technology for improving heat dissipation performance of the lamps.

### BACKGROUND ART

In recent years, in accordance with advancement of semiconductor technology, there are increasing demands for lamps that use solid-state light emitting devices as light sources.

Since such lamps have reduced power consumption and long lives, they greatly contribute to promotion of saving of energy, and it is anticipated that they will explosively spread throughout the world in the future.

Here, a conventional LED lamp is disclosed in Patent Literature 1.

According to Patent Literature 1, it is described that the LED lamp includes a heat dissipation member including a plurality of plate portions that are arranged in parallel with each other and connected to each other, and thus, “since the surface area per unit weight of the heat dissipation member is large due to the plurality of plate portions, the area contacting the outside air becomes relatively large even when the heat dissipation member is relatively light in weight. Therefore, the LED lamp can realize a lamp having a reduced weight and sufficient heat dissipation performance”.

### CITATION LIST

### Patent Literature

[PTL 1] Japanese Laid-open Patent Publication No. 2009-277483.

### SUMMARY OF THE INVENTION

### Problems to be Solved by the Invention

With respect to a solid-state light emitting device such as an LED and an EL, the light emission efficiency tends to decrease in accordance with an increase in a temperature, and the heat dissipation performance needs to be improved.

Major causes of the increase in the temperature of the solid-state light emitting device that can be considered are: the first cause in which electric power that has not been changed into light at the solid-state light emitting device changes into heat; and the second cause in which, of the light absorbed by a wavelength conversion member such as a fluorescent material, light that has not been converted changes into heat. According to an actual measurement by the inventors, it was found that the temperature is higher on a side from which light is taken out and on which heat generation influence mainly due to the second cause is strong, than on the reverse side of the side from which light is taken out and on which heat generation influence mainly due to the first cause is strong.

As measures to be taken against the first cause, there are examples, as in Patent Literature 1, in which a heat dissipation member is arranged to the reverse side of the side from which light is taken out, thereby positively dissipating the heat. In this manner, in the conventional technology, a measure for the heat dissipation against the first cause is taken as a priority. However, no example has been found in which measures against the second cause are taken as a priority.

In order to improve the heat dissipation performance, a metal heat dissipation member (corresponding to a heat dissipation member 20 in Patent Literature 1) is provided in general on the reverse side of a side from which light is taken out. However, by use of the heat dissipation member, the weight of the lamp is increased by the weight of the heat dissipation member. Accordingly, there are disadvantages in which attachment of the lamp to an apparatus is restricted due to the increase of the weight, work burden during attachment or replacement of the lamp is increased, resulting in raised costs for transportation, and the like.

Moreover, in a case where the space between a light-emitting module and the inner wall of the housing is made to be hollow, reflection of light at the interface between the surface from which light is taken out and the hollow portion and reflection of light at the interface between the housing inner wall and the hollow portion cause the efficiency of taking out light to be reduced. Then, if the hollow portion is filled with a member such as a translucent resin, the reflection at the interfaces is suppressed but the weight is increased by the weight of the member such as the translucent resin. Therefore, a similar problem to that described above occurs.

On the other hand, since the above lamp has sufficiently reduced power consumption and long life compared with a conventional fluorescent tube, it is desired that such lamps are used in every developing country as well as advanced countries. Therefore, development of an LED lamp that is inexpensive and has a structure as simple as possible is desired. However, it is necessary to prevent the light emission efficiency from being reduced and the life of the lamp from being shortened. Therefore, it is necessary to develop a lamp that is not only inexpensive and simply structured and but also has an improved heat dissipation performance.

Therefore, an object of the present invention is to provide a lamp, designed to use a solid-state light emitting device as a light source, which has a simple and inexpensive structure and, at the same time, has an improved heat dissipation performance. To be specific, an object of the present invention is to, in a lamp designed to use a solid-state light emitting device as a light source, take measures in priority against temperature increase relating to a wavelength conversion member, and to suppress weight increase caused by addition of a heat dissipation member and by filling a hollow portion with a member such as translucent resin.

### Solution to the Problems

The present invention is directed to a lamp designed to use a solid-state light emitting device as a light source. In order to solve the above problems, the lamp designed to use a solid-state light emitting device as a light source according to the present invention includes a cap, a housing, and a light-emitting module. The cap is attached to an external apparatus at the time of use. The housing is made of a translucent material and is connected to the cap 110. The light-emitting module includes one or a plurality of solid-state light emitting devices, and is mounted such that a main-light-emission side of the light-emitting module is in close contact with an inner wall of the housing.

Further, in the lamp designed to use the solid-state light emitting device as the light source, a gap between the housing and the light-emitting module may be filled with a thermal conductive material having a translucency and a thermal conductivity.

Further, in the lamp designed to use the solid-state light emitting device as the light source, a portion of a surface of the housing at which the light-emitting module is mounted may be shaped as a curved surface, the main-light-emission side of the light-emitting module may be shaped as a flat surface, and the thermal conductive material may function as a lens by filling the gap between the housing and the light-emitting module.

Further, in the lamp designed to use the solid-state light emitting device as the light source, a film of a wavelength conversion member may be formed on at least the portion of the housing at which the light-emitting module is mounted.

Further, the lamp designed to use the solid-state light emitting device as the light source may further include a reflector plate in a space in the housing, at a rear side of the main-light-emission side of the light-emitting module.

Further, the lamp designed to use the solid-state light emitting device as the light source may further include an elastic body in the housing, the elastic body pressing a rear side of the main-light-emission side of the light-emitting module toward the main-light-emission side such that the main-light-emission side of the light-emitting module is pressed against the inner wall of the housing.

Further, the lamp designed to use the solid-state light emitting device as the light source may further include a plurality of the light-emitting modules, and the elastic body concurrently may press the plurality of the light-emitting modules toward the respective main-light-emission sides.

Further, in the lamp designed to use the solid-state light emitting device as the light source, the elastic body may be mounted so as to be in close contact with rear sides of the respective plurality of the light-emitting modules, and may thermally bond the plurality of the light-emitting modules.

Further, in the lamp designed to use the solid-state light emitting device as the light source, the housing may be sealed, may include the light-emitting module mounted inside the sealed housing, and may be filled with an inert gas.

Further, the lamp designed to use the solid-state light emitting device as the light source may include a drive circuit mounted so as to be in close contact with the inner wall of the housing, operable to drive and cause the one or the plurality of solid-state light emitting devices to emit light, the housing may include a portion of a substantially cylindrical shape, and the light-emitting module and the drive circuit may be mounted at opposing positions, respectively, in an inner periphery of the portion of the substantially cylindrical shape.

Here, a lamp module designed to use a solid-state light emitting device as a light source according to the present invention includes a flat plate and a light-emitting module. The flat plate is made of a translucent material having a flat plate shape, the flat plate configured to be, as a front panel of a lighting apparatus, directly attached to the lighting apparatus at the time of use. The light-emitting module includes one or a plurality of solid-state light emitting devices, and is mounted such that a main-light-emission side of the light-emitting module is in close contact with a rear surface of a surface which is to be used as a light emission surface of the flat plate.

Further, in the lamp module designed to use the solid-state light emitting device as the light source, a gap between the flat plate and the light-emitting module may be filled with a thermal conductive material having a translucency and a thermal conductivity.

Further, in the lamp module designed to use the solid-state light emitting device as the light source, a film of a wavelength conversion member may be formed on a portion, of the flat plate, at which the light-emitting module is mounted.

Here, a lamp module designed to use a solid-state light emitting device as a light source according to the present invention includes a heat sink and a light-emitting module. The heat sink has a thermal conductivity to be attached to a rear surface of a surface, of a panel made of a translucent material included in an external apparatus, to be used as a light emission surface. The light-emitting module includes one or a plurality of solid-state light emitting devices, and fixed to the heat sink such that, when the heat sink is attached to the panel, a main-light-emission side of the solid-state light emitting device is in close contact with the panel.

Further, in the lamp module designed to use the solid-state light emitting device as the light source, a thermal conductive material having a translucency and a thermal conductivity may be placed on a surface of the main-light-emission side of the light-emitting module.

Further, the lamp module designed to use the solid-state light emitting device as the light source may be provided with an adhesive agent having a thermal conductivity at a portion of the heat sink to be attached to the panel.

Further, the lamp module designed to use the solid-state light emitting device as the light source may include a drive circuit configured to drive and cause the one or the plurality of solid-state light emitting devices to emit light, and mounted at a position where, when the heat sink is attached to the panel, the drive circuit is not seen through the panel.

With respect to the translucent material, the coefficient of thermal conductivity and the thermal radiation can be increased by use of a translucent hard brittle material such as glass, and the translucent material can be made difficult to be broken, by use of a material using resins.

### Advantageous Effects of the Invention

As described above, in the lamp designed to use the solid-state light emitting device as a light source according to the present invention, the light-emitting module is mounted such that the main-light-emission side thereof is in close contact with the inner wall of the housing. Therefore, without particular components such as a heat sink or a fan for heat dissipation, it is possible to release heat generated due to the light-emitting module into the housing, and to dissipate the heat from the surface of the housing to the outside.

Therefore, according to the above configuration, it is possible to improve the heat dissipation performance with a simple and inexpensive structure. Accordingly, without using a metal heat dissipation member, it is possible to obtain the heat dissipation characteristic necessary for ensuring the light emission efficiency and the lifetime characteristic.

Further, by filling the gap between the housing and the light-emitting module with the thermal conductive material, heat generated by the light-emitting module can be efficiently conveyed to the housing, and not only the heat dissipation performance but also the efficiency for obtaining light can be ensured.

Further, by the thermal conductive material filling the gap between the curved surface and the flat surface and concurrently functioning as a lens, it is possible to set as desired a light distribution characteristic without providing a lens separately.

Further, by forming the phosphor film on at least the portion, of the housing, at which the light-emitting module is mounted, it is possible to directly convey to the housing heat generated through the wavelength conversion by the phosphor film, whereby the heat dissipation efficiency can be enhanced.

Further, by the provision of the reflector plate, light advancing toward the rear side of the main-light-emission side of the light-emitting module is reflected, whereby the brightness can be improved.

Further, by the elastic body pressing the light-emitting module against the inner wall of the housing, the degree of closeness of the contact between the light-emitting module and the housing can be maintained.

Further, by the elastic body concurrently pressing a plurality of light-emitting modules against the inner wall of the housing, the degree of closeness of the contact between the plurality of light-emitting modules and the housing can be maintained with a simple and inexpensive structure.

Further, by the elastic body thermally bonding the plurality of light-emitting modules, the variation in temperature among the light-emitting modules can be reduced, and the variation in colors of emitted light can be suppressed.

Further, by the light-emitting module being mounted and sealed in the housing, and by the housing being filled with an inert gas, the durability and the reliability of the light-emitting module can be greatly improved.

Further, by mounting the light-emitting module and the drive circuit at opposing positions on the inner periphery of a substantially cylindrical portion of the housing, the heat sources are separated and heat dissipation from the housing to the outside can be efficiently performed.

Further, in the lamp module designed to use the solid-state light emitting device as the light source, the main-light-emission side of the light-emitting module is mounted so as to be in close contact with the main surface of the flat plate. Therefore, it is possible to release heat generated due to the light-emitting module to the flat plate and to dissipate the heat from the surface of the flat plate to the outside, without a particular provision of a heat sink, a fan, and the like for heat dissipation.

Therefore, according to the above configurations, it is possible to improve the heat dissipation performance with a simple and inexpensive structure.

Further, by filling the gap between the flat plate and the light-emitting module with the thermal conductive material, heat generated by the light-emitting module can be efficiently conveyed to the flat plate.

Further, by forming the phosphor film on the flat plate, heat generated through the wavelength conversion by the phosphor film can be directly conveyed to the flat plate, whereby the heat dissipation efficiency can be enhanced.

Further, in the lamp module designed to use the solid-state light emitting device as the light source, the heat sink is attached to a panel of an external apparatus, and the main-light-emission side of the light-emitting module is in close contact with the panel of the external apparatus. Accordingly, heat generated due to the light-emitting module can be released to the heat sink and the panel, and the heat can be dissipated from the surfaces of the heat sink and of the panel to the outside.

Therefore, according to the above configurations, the heat dissipation performance can be improved with a simple and inexpensive structure.

Further, since the thermal conductive material having a translucency and a thermal conductivity is mounted on the main-light-emission side of the light-emitting module, heat from the light-emitting module can be conveyed to the panel and the heat can be dissipated from the surface of the panel to the outside.

Further, an adhesive agent having a thermal conductivity is provided at a portion of the heat sink that is to be attached to a panel of an external apparatus. Therefore, the heat sink can be easily attached to a panel of an existing external apparatus, thereby realizing a high versatility. Further, heat from the heat sink can be conveyed to the panel and then dissipated from the surface of the panel to the outside.

Further, by the provision of the drive circuit, the lamp can be easily attached to an existing external apparatus, thereby realizing a high versatility.

### BRIEF DESCRIPTION OF THE DRAWINGS

FIG. 1 shows an external view of a lamp 100 designed to use a solid-state light emitting device as a light source, according to a first embodiment.

FIG. 2 shows the lamp 100 in FIG. 1 viewed in a lateral direction A in FIG. 1.

FIG. 3 shows a cross section of the lamp 100 cut along chain line B-B′ in FIG. 2, viewed from a direction C in FIG. 2.

(a) of FIG. 4 shows a cross section of individual LED devices sealed by wavelength conversion members, respectively, and (b) of FIG. 4 shows a cross section of a plurality of LED devices collectively sealed by a wavelength conversion member.

FIG. 5 shows a lamp 200 designed to use a solid-state light emitting device as a light source, according to a first modification, viewed in a lateral direction.

FIG. 6 shows a cross section of the lamp 200 cut along chain line D-D′ in FIG. 5, viewed from a direction E in FIG. 5.

FIG. 7 shows a lamp 300 designed to use a solid-state light emitting device as a light source, according to a second modification, viewed in a lateral direction.

FIG. 8 shows a cross section of the lamp 300 cut along chain line F-F′ in FIG. 7, viewed from a direction G in FIG. 6.

FIG. 9 shows a lamp 400 designed to use a solid-state light emitting device as a light source, according to a third modification, viewed in a lateral direction.

FIG. 10 shows a cross section of the lamp 400 cut along chain line H-H′ in FIG. 9, viewed from a direction I in FIG. 8.

FIG. 11 shows a lamp 500 designed to use a solid-state light emitting device as a light source, according to a fourth modification, viewed in a lateral direction.

FIG. 12 shows a cross section of the lamp 500 cut along chain line J-J′ in FIG. 11, viewed from a direction K in FIG. 11.

FIG. 13 shows a lamp 600 designed to use a solid-state light emitting device as a light source, according to a fifth modification, viewed in a lateral direction.

FIG. 14 shows a cross section of the lamp 600 cut along chain line L-L′ in FIG. 13, viewed from a direction M in FIG. 12.

FIG. 15 shows a lamp 700 designed to use a solid-state light emitting device as a light source, according to a sixth modification, viewed in a lateral direction.

FIG. 16 shows a cross section of the lamp 700 cut along chain line N-N′ in FIG. 15, viewed from a direction O in FIG. 15.

FIG. 17 shows a lamp 800 designed to use a solid-state light emitting device as a light source, according to a seventh modification, viewed from a lateral direction.

FIG. 18 shows a cross section of the lamp 800 cut along chain line P-P′ in FIG. 17, viewed from a direction Q in FIG. 17.

FIG. 19 shows a lamp 801 in which elastic bodies 850a and 850b are replaced with another elastic body and is a cross section corresponding to that in FIG. 17.

FIG. 20 shows an example in which the elastic bodies 850a and 850b are replaced with an elastic body having a good thermal conductivity and is a cross section corresponding to that in FIG. 17.

FIG. 21 shows a lamp 900 designed to use a solid-state light emitting device as a light source, according to a ninth modification, viewed in a lateral direction.

FIG. 22 shows a lamp 1000 designed to use a solid-state light emitting device as a light source, according to a second embodiment, viewed from a light emission surface.

FIG. 23 shows a cross section of a lamp 1000 cut along chain line R-R′ in FIG. 22, viewed in a lateral direction S in FIG. 21.

FIG. 24 shows a cross section of a lamp 1100 according to a tenth modification, viewed in a lateral direction, the cross section corresponding to that in FIG. 23.

FIG. 25 shows a film of a wavelength conversion member formed on an inner wall of a housing, around a position at which a light-emitting module is mounted, based on the lamp 100 according to the first embodiment.

FIG. 26 shows a film of a wavelength conversion member formed on a flat plate, around a position at which a light-emitting module is mounted, based on the lamp 1000 according to the second embodiment.

### DESCRIPTION OF EMBODIMENTS

### First Embodiment

<Outline>

According to a first embodiment, in a lamp that has a simple basic structure, includes a cap, a housing, and a light-emitting module, and is designed to use a solid-state light emitting device as a light source, a light emission surface of the light-emitting module is caused to be in close contact with an inner surface of the housing.

According to this configuration, without adding an expensive structure for heat dissipation, the heat dissipation performance can be improved through a simple structure. Therefore, it is possible to suppress the light emission efficiency from being reduced and the life of the lamp from being shortened. Thus, it is possible to provide a lamp that is inexpensive, has reduced power consumption, and has a long life.

Further, by filling the gap between the housing and the light-emitting module with a thermal conductive material, the heat dissipation performance is improved.

<Configuration>

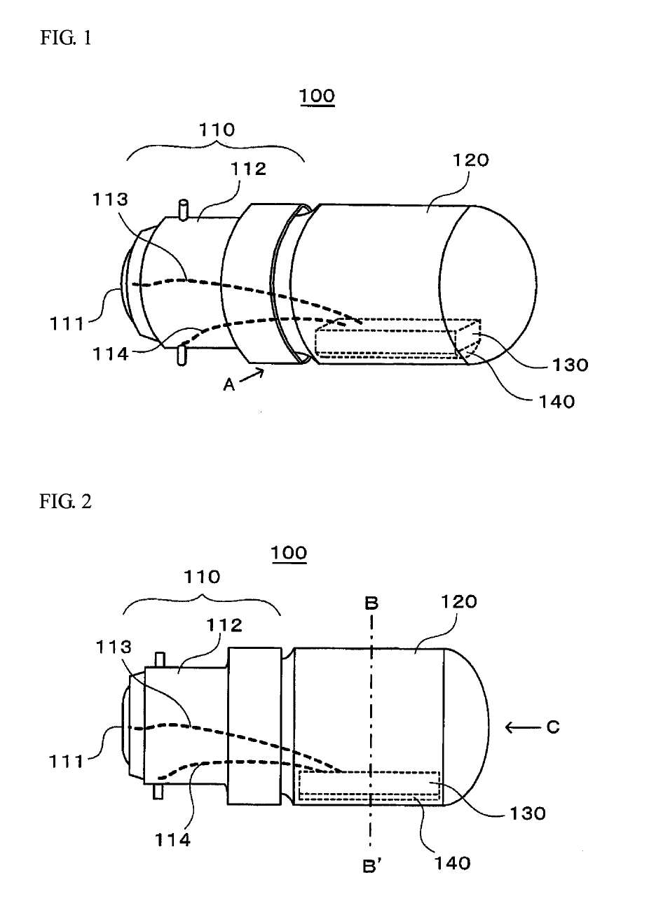

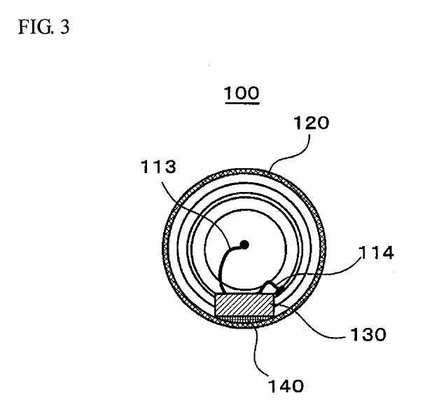

FIG. 1 shows an external view of a lamp 100 designed to use a solid-state light emitting device as a light source, according to a first embodiment. FIG. 2 shows the lamp 100 in FIG. 1 viewed in a lateral direction A in FIG. 1. FIG. 3 shows a cross section of the lamp 100 cut along chain line B-B′ in FIG. 2, viewed from a direction C in FIG. 2.

As shown in FIGS. 1 to 3, the lamp 100 according to the first embodiment includes a cap 110, a housing 120, and a light-emitting module 130, and the gap between the housing 120 and the light-emitting module 130 is filed with a thermal conductive material 140.

It should be noted that although this embodiment employs a lamp of a type that does not include a drive circuit in the housing, a lamp of a type that includes a drive circuit in the housing may be employed.

The cap 110 is formed of a structure material such as metal or resin and is a portion to be attached to an external apparatus at the time of use. The cap 110 includes electrodes 111 and 112 and lead wires 113 and 114. Each of the electrodes 111 and 112 is made of a conductive substance such as metal, and the two electrodes have to be insulated from each other. Moreover, the electrodes 111 and 112 are connected to the light-emitting module 130 via the lead wires 113 and 114, respectively, and are supplied with electric power.

The housing 120 is a transparent case formed of a translucent material, and the opening portion of the housing 120 is connected to the cap 110. As the translucent material, for example, epoxy resins, glass, silicone resins, polycarbonate resins, acrylic resins, or the like may be employed. In this embodiment, the housing 120 has a substantially columnar shape whose body portion has a substantially cylindrical shape. The lower base of the substantially columnar shape is formed as an opening portion, and the upper base thereof has a dome shape that is slightly swelled outwardly. It should be noted that the shape of the housing 120 is not limited thereto. For example, the shape of a cross section, along a direction parallel to the upper base or the lower base, of the body portion may be a shape other than a circle, such as a polygon, may be cornered, or may include curves and straight lines in a mixed manner.

The light-emitting module 130 is a module for lighting, which is implemented as one solid-state light emitting device such as an LED or an EL or as a unit composed of a plurality of solid-state light emitting devices. It should be noted that the light-emitting module 130 may be a unit of LEDs or ELs which each emit a single color such as red, green, or blue, or may use LEDs and ELs of these respective colors in combination as appropriate so as to emit white color or any other colors. Alternatively, the light-emitting module 130 may be a module in which a wavelength conversion member is molded around LEDs such that white color or any other colors are emitted. Here, the wavelength conversion member is a member that contains a substance that absorbs light whose wave lengths are relatively short such as blue light or ultraviolet rays and that emits light having wave lengths longer than the absorbed light. Generally, an inorganic fluorescent material such as a YAG phosphor, a silicate phosphor, or an oxynitride phosphor, or a ceramic fluorescent material formed by sintering these inorganic fluorescent materials is used as the wavelength conversion member. Examples other than the above include rare earth doped glass fluorescent materials, organic fluorescent materials, metallic complex fluorescent materials, and the like. For example, the light-emitting module 130 may be one in which a fluorescent material that converts blue light into light of a complementary color of blue is molded around a blue-light-emitting LED so as to emit white light. Alternatively, the light-emitting module 130 may be implemented as an LED that emits a single color, and a phosphor film is formed inside the body of the housing 120 or a surface of the body such that a desired color is emitted. An example in which a phosphor film is formed on a surface of the inner wall of the body of the housing 120 will be described in detail in an eleventh modification below.

Alternatively, the light-emitting module 130 may take one of a form in which a wavelength conversion member is mounted on a module substrate where an LED device is primarily mounted and a form in which a package composed of an LED device and a fluorescent material is secondarily mounted on a module substrate.

Further, white LEDs that have different color temperatures with each other may be combined as appropriate. Moreover, the color can be adjusted on the blackbody locus.

As shown in the cross-sectional view in (a) of FIG. 4, the light-emitting module 130 may take a form in which a plurality of LED devices 132a to 132c are mounted on a module substrate 131 and the LED devices 132a to 132c are sealed with wavelength conversion members 133a to 133c, respectively, which are each a silicone resin or the like containing a YAG phosphor or the like dispersed therein. Alternatively, as shown in the cross-sectional view in (b) of FIG. 4, the light-emitting module 130 may take a form in which a plurality of LED devices 135a to 135f are mounted on a module substrate 134 and collectively sealed with a wavelength conversion member 136. In the case of the collective sealing in a sheet-like shape as shown in (b) of FIG. 4, diffused light is emitted.

Here, as a sealing material for the light-emitting module 130, a fluorinated resin, sol-gel glass, low melting glass, or the like can be considered, in addition to a silicone resin. In particular, since sol-gel glass and low melting glass are each an inorganic material, they are excellent in the heat resistance and the light resistance, and are superior for realizing high-output. Moreover, in order to improve the thermal conductivity, the thixotropy, and the light diffusion property (mixture of LED light and fluorescent light), it is preferable to add, to the sealing material, particles (nano particles of several nm to several hundred nm, and micro particles of several μm to several tens μm) of translucent metal oxides, nitrides, or carbides (silicon oxide, titanium oxide, zinc oxide, zirconium oxide, aluminium oxide, aluminium nitride, silicon nitride, boron nitride, silicon carbide, or the like).

Here, the light-emitting module 130 is mounted such that the main-light-emission side (lower side in FIGS. 1 to 3) thereof is in close contact with the inner wall of the housing 120. It should be noted that, as in a case where the shape of the main-light-emission side of the light-emitting module 130 and the shape of the inner wall of the housing 120 are both, for example, flat, if the shapes of the respective portions that contact with each other fit each other, both portions can be caused to be in close contact with each other, without particular measures being taken. However, in this embodiment, the main-light-emission side of the light-emitting module 130 has a flat surface but the inner wall of the housing 120 (the inner periphery of the substantially columnar shaped portion) has a curved surface. Therefore, if no measures are taken, the shapes of the contacting portions do not fit each other, thereby creating a gap therebetween. Therefore, the gap therebetween is filled with the thermal conductive material 140, to cause both portions to be in close contact with each other. Even when the shape of the contacting portions fit each other, if the gap therebetween is filled with the thermal conductive material 140, it is possible to cause both portions to be in close contact with each other in a more assured manner.

The thermal conductive material 140 is a filling material that has a translucency and a thermal conductivity such as a silicone grease, and fills the gap between the housing 120 and the light-emitting module 130. It should be noted that the thermal conductive material 140 may be a silicone-based resin or a fluorinated resin, and preferably, has adhesiveness, fixing characteristics, and light resistance. Moreover, in order to improve the thermal conductivity, the thixotropy, and the light diffusion property (mixture of LED light and fluorescent light), it is preferable to add, to the thermal conductive material 140, particles (nano particles of several nm to several hundred nm, and micro particles of several μm to several tens μm) of translucent metal oxides, nitrides, or carbides (silicon oxide, titanium oxide, zinc oxide, zirconium oxide, aluminium oxide, aluminium nitride, silicon nitride, boron nitride, silicon carbide, or the like).

In this embodiment, the gap between the housing 120 and the light-emitting module 130 has a similar shape to that of a cylindrical lens, and the gap is filled with the thermal conductive material 140, whereby the gap functions as a cylindrical lens. Accordingly, not only the heat dissipation performance but also the diffuseness can be improved. It should be noted that by changing the shape of the gap as appropriate or by selectively using a material having an appropriate refractive index for the thermal conductive material 140, it is possible to form various lenses having desired characteristics in a relatively easy manner.

[First Modification]

<Outline>

According to a first modification, the upper base of the housing having the substantially columnar shape is implemented as a substantially flat plate, and the light-emitting module is mounted such that the main-light-emission side thereof is in close contact with the inner wall of the substantially flat plate of the upper base.

<Configuration>

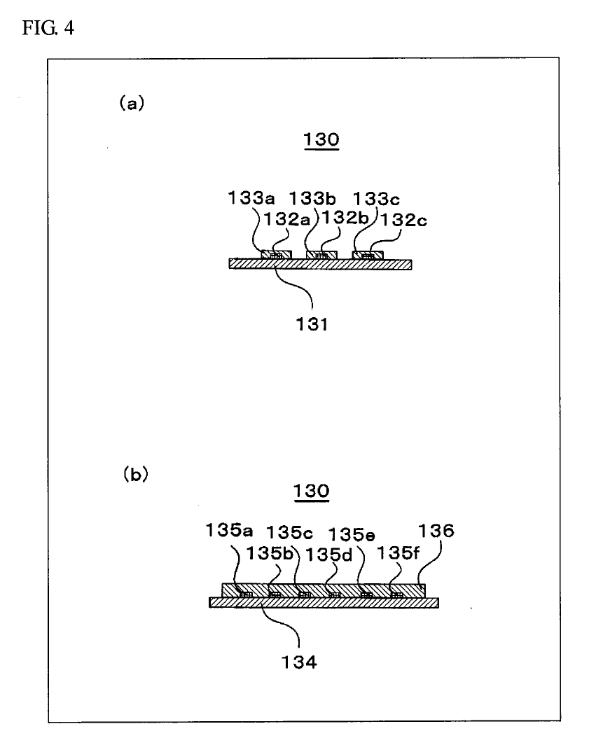

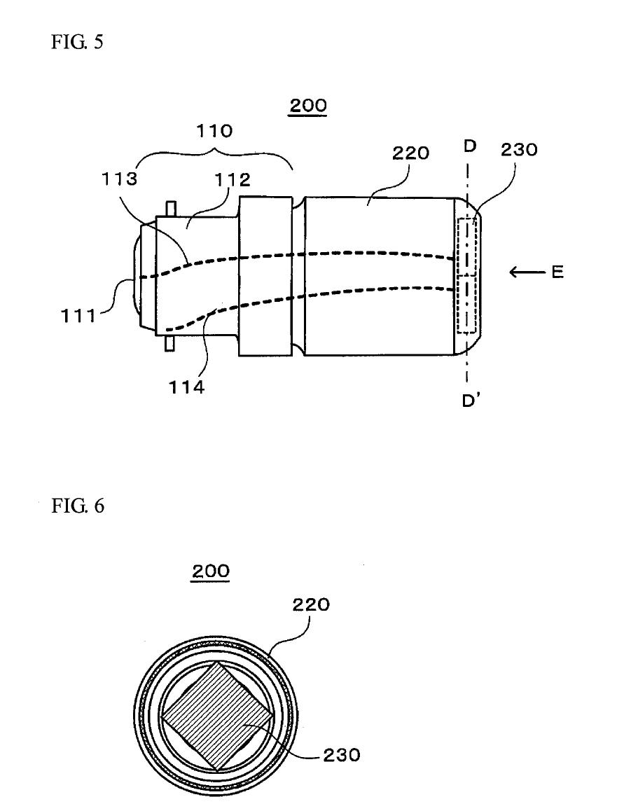

FIG. 5 shows a lamp 200 designed to use a solid-state light emitting device as a light source, according to the first modification, viewed in a lateral direction. FIG. 6 shows a cross section of the lamp 200 cut along chain line D-D′ in FIG. 5, viewed from a direction E in FIG. 5.

As shown in FIGS. 5 and 6, the lamp 200 according to the first modification includes the cap 110, a housing 220, and a light-emitting module 230.

In FIGS. 5 and 6, components having similar functions to those of the components of the lamp 100 according to the first embodiment are denoted by the same reference numerals as those of the components of the lamp 100.

The housing 220 is a case made of a translucent material and the opening portion of the housing 220 is connected to the cap 110, as in the case of the housing 120 according to the first embodiment. In the first modification, the housing 220 has a substantially columnar shape whose body portion has a substantially cylindrical shape. The lower base of the substantially columnar shape is formed as an opening portion, and the upper base thereof has a substantially circular flat plate shape.

The light-emitting module 230 and the light-emitting module 130 of the first embodiment are different from each other only in their shapes.

Here, the light-emitting module 230 is mounted such that the main-light-emission side (right side in FIG. 5) thereof is in close contact with the inner wall of the top end portion (the substantially circular flat plate portion corresponding to the upper base) of the housing 220. Here, the shape of the main-light-emission side of the light-emitting module 230 and the shape of the inner wall of the top end portion of the housing 220 are each flat. Accordingly, both portions can be caused to be substantially in close contact with each other, without placing the thermal conductive material 140 therebetween as in the first embodiment. It should be noted that if the thermal conductive material 140 is placed therebetween, both portions can be in close contact with each other in a more assured manner, whereby improvement of the thermal conductivity can be expected.

[Second Modification]

<Outline>

According to a second modification, the inner surface of the upper base of the housing having the substantially columnar shape is a flat surface and the outer surface thereof has a dome shape, thereby forming a lens at the top end portion of the housing, and the light-emitting module is mounted such that the main-light-emission side thereof is in close contact with the inner wall of this lens.

<Configuration>

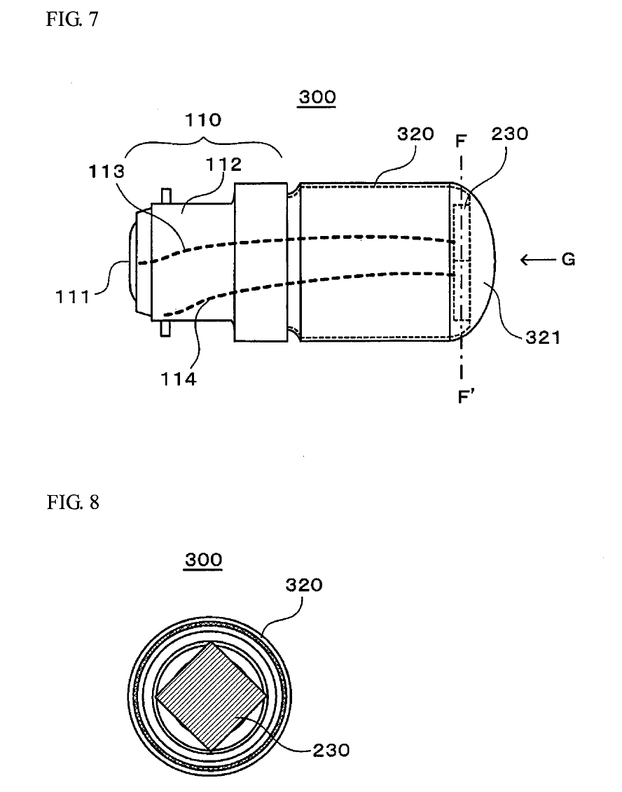

FIG. 7 shows a lamp 300 designed to use a solid-state light emitting device as a light source, according to a second modification, viewed in a lateral direction. FIG. 8 shows a cross section of the lamp 300 cut along chain line F-F′ in FIG. 7, viewed from a direction G in FIG. 7.

As shown in FIGS. 7 and 8, the lamp 300 according to the second modification includes the cap 110, a housing 320, and the light-emitting module 230.

In FIGS. 7 and 8, components having similar functions to those of the components of the lamp 100 according to the first embodiment and the components in the lamp 200 according to the first modification are denoted by the same reference numerals as those of their corresponding components.

The housing 320 is a transparent case formed of a translucent material and the opening portion of the housing 320 is connected to the cap 110, as in the case of the housing 120 according to the first embodiment. In the second modification, the housing 320 has a substantially columnar shape whose body portion has a substantially cylindrical shape. The lower base of the substantially columnar shape is formed as an opening portion, and the upper base thereof is formed as a lens 321 by the inner surface of the upper base having a flat surface and the outer surface of the upper base having a dome shape.

Here, the light-emitting module 230 is mounted such that the main-light-emission side (right side in FIG. 7) thereof is in close contact with the inner wall of the top end portion (lens portion corresponding to the upper base) of the housing 320. Here, as in the first modification, the shape of the main-light-emission side of the light-emitting module 230 and the shape of the inner wall of the top end portion of the housing 320 are each flat. Accordingly, both portions can be caused to be substantially in close contact with each other, without placing the thermal conductive material 140 as in the first embodiment. It should be noted that if the thermal conductive material 140 is placed therebetween, both portions can be in close contact with each other in a more assured manner, whereby improvement of the thermal conductivity can be expected.

[Third Modification]

<Outline>

According to a third modification, a reflector plate is provided in a space in the housing, such that light advancing toward the rear side of the main-light-emission side of the light-emitting module is reflected, thereby improving the brightness on the main-light-emission side.

<Configuration>

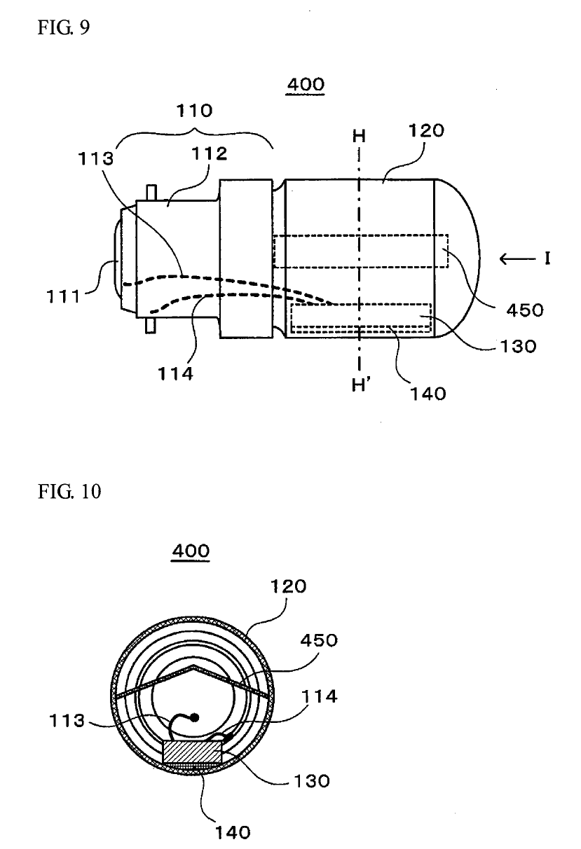

FIG. 9 shows a lamp 400 designed to use a solid-state light emitting device as a light source, according to a third modification, viewed in a lateral direction. FIG. 10 shows a cross section of the lamp 400 cut along chain line H-H′ in FIG. 9, viewed from a direction I in FIG. 9.

As shown in FIGS. 9 and 10, the lamp 400 according to the third modification includes the cap 110, the housing 120, and the light-emitting module 130, and the gap between the housing 120 and the light-emitting module 130 is filled with the thermal conductive material 140. The lamp 400 further includes a reflector plate 450 in a space in the housing 120, on the rear side of the main-light-emission side (lower side in FIGS. 9 and 10) of the light-emitting module 130.

It should be noted that components in FIGS. 9 and 10 having similar functions to those of the components of the lamp 100 according to the first embodiment are denoted by the same reference numerals as those of the components of the lamp 100.

The reflector plate 450 is made of a material having a high reflectance such as, for example, a molded resin having aluminium deposited on its surface to increase the reflectance, a mirror-finish stainless steel, or a plated steel.

In this manner, through the provision of the reflector plate 450, the light advancing toward the rear side of the main-light-emission side of the light-emitting module 130 is reflected, whereby the brightness on the main-light-emission side can be improved.

[Fourth Modification]

<Outline>

A lamp according to a fourth modification is directed to an E-cap type lamp for an electric bulb socket or the like. Since such a cap is of a threaded type, the light-emitting direction cannot be fixed. Therefore, a mechanism for adjusting the light distribution direction is added.

<Configuration>

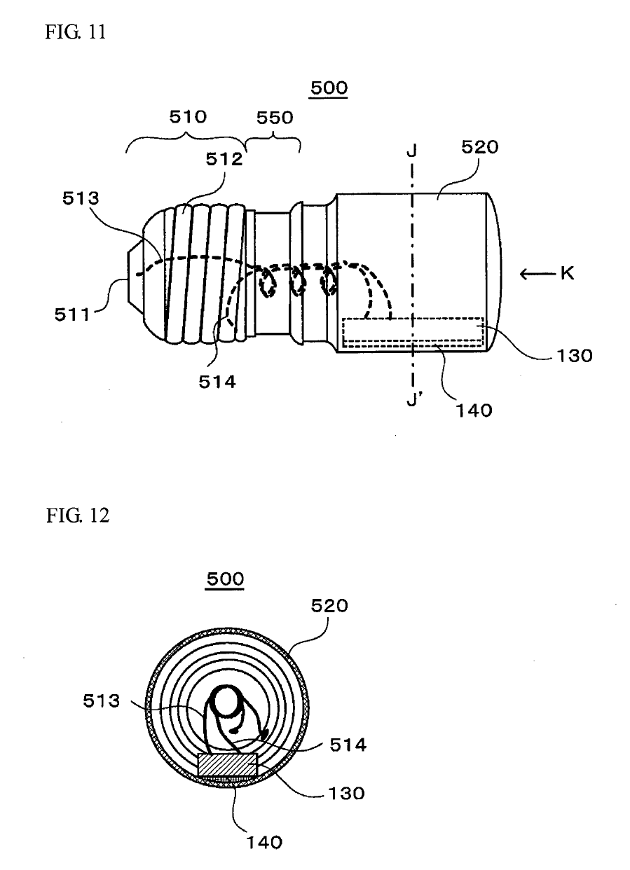

FIG. 11 shows a lamp 500 designed to use a solid-state light emitting device as a light source, according to the fourth modification, viewed in a lateral direction. FIG. 12 shows a cross section of the lamp 500 cut along chain line J-J′ in FIG. 11, viewed from a direction K in FIG. 11.

As shown in FIGS. 11 and 12, the lamp 500 according to the fourth modification includes a cap 510, a housing 520, and the light-emitting module 130. The gap between the housing 520 and the light-emitting module 130 is filled with the thermal conductive material 140. The lamp 500 further includes a light distribution adjustment mechanism part 550 between the cap 510 and the housing 520.

It should be noted that in FIGS. 11 and 12, components having similar functions to those of the components of the lamp 100 according to the first embodiment are denoted by the same reference numerals as those of the components of the lamp 100.

The cap 510 is formed of a structure material such as metal or resin, and is a portion to be attached to an external apparatus at the time of use. For example, the cap 510 is an E-cap of a threaded-type, and includes electrodes 511 and 512, and lead wires 513 and 514. Each of the electrodes 511 and 512 is made of a conductive substance such as metal and these two electrodes have to be insulated from each other. Moreover, the electrodes 511 and 512 are connected to the light-emitting module 130 via the lead wires 513 and 514, respectively, and are supplied with electric power.

The housing 520 is a transparent case formed of a translucent material, and the opening portion the housing 520 is connected to the cap 510. In this embodiment, the housing 520 has a substantially columnar shape whose body portion has a substantially cylindrical shape. The lower base of the substantially columnar shape is formed as an opening portion, and the upper base has a slightly swelled shape.

Here, the light-emitting module 130 is mounted such that the main-light-emission side (lower side in FIGS. 11 and 12) thereof is in close contact with the inner wall of the housing 520. The detailed relationship therebetween is similar to the relationship between the housing 120 and the light-emitting module 130 in the lamp 100 according to the first embodiment.

The light distribution adjustment mechanism part 550 is configured to be able to adjust as desired a relative rotation angle between the cap 510 and the housing 520 in a range of about 360 degrees, and has a stopper (not shown) for preventing excessive rotations, so as to prevent the cap 510 and the housing 520 from rotating many times relative to each other, resulting in disconnection of the lead wires 513 and 514.

The lead wires 513 and 514 are each covered so as to be able to endure torsion caused by the relative rotation between the cap 510 and the housing 520, middle portions of the lead wires 513 and 514 are bundled together, and the bundled portion is shaped into a coil.

As described above, in the case of the threaded type cap such as the cap 510, when the cap is attached to a lighting apparatus, the light-emitting module 130 is not always oriented in a direction in which light is desired to be emitted. Therefore, in this modification, the light distribution adjustment mechanism part 550 is provided such that the light distribution direction can be adjusted.

[Fifth Modification]

<Outline>

According to a fifth modification, a drive circuit is mounted, along with the light-emitting module, in the housing such that the drive circuit is in close contact with the inner wall of the housing.

<Configuration>

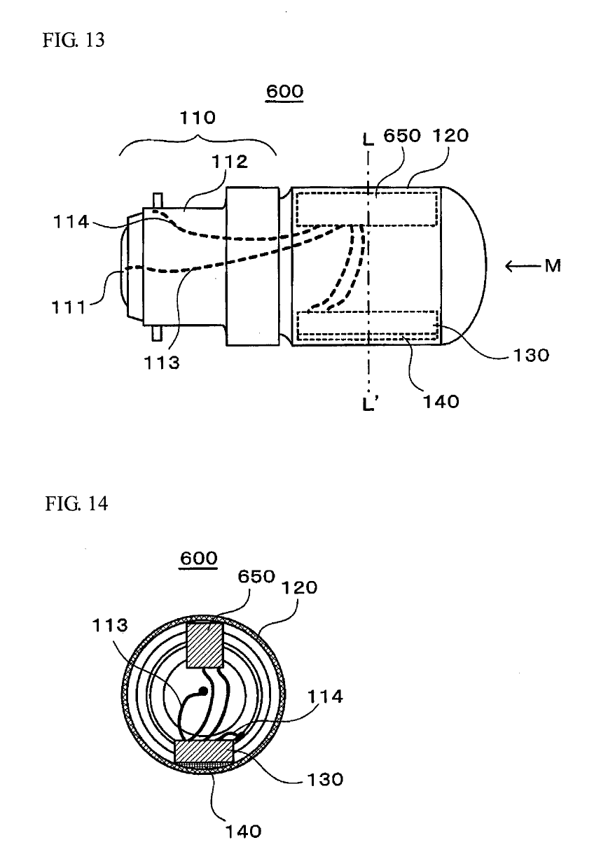

FIG. 13 shows a lamp 600 designed to use a solid-state light emitting device as a light source, according to the fifth modification, viewed in a lateral direction. FIG. 14 shows a cross section of the lamp 600 cut along chain line L-L′ in FIG. 13, viewed from a direction M in FIG. 13.

As shown in FIGS. 13 and 14, the lamp 600 according to the fifth modification includes the cap 110, the housing 120, and the light-emitting module 130. The gap between the housing 120 and the light-emitting module 130 is filled with the thermal conductive material 140. The lamp 600 further includes a drive circuit 650 in the housing 120.

It should be noted that in FIGS. 13 and 14, components having similar functions to those of the components of the lamp 100 according to the first embodiment are denoted by the same reference numerals as those of the components of the lamp 100.

The drive circuit 650 is an electronic circuit for outputting an electric power appropriate for lighting the light-emitting module 130. In a case where a general household power source (AC100V or AC200V) is used as an input power source, for example, the drive circuit 650 includes: primary side circuit elements such as a rectification diode and an inductor; and a switching transistor. In a case where a DC power source (DC6V, 12V, 24V, or the like) is used as an input power source, for example, the drive circuit 650 includes: primary side circuit elements such as a capacitor and an inductor; and a switching transistor.

Here, in this modification, the light-emitting module 130 is mounted such that the main-light-emission side (lower side in FIGS. 13 and 14) thereof is in close contact with the inner periphery of the substantially cylindrical shaped body portion of the housing 120, and in addition, the drive circuit 650 is mounted at a farthermost position (upper side in FIGS. 13 and 14) from the light-emitting module 130 in the inner periphery, so as to face the light-emitting module 130.

By mounting the light-emitting module 130 and the drive circuit 650 at opposing positions at which they face each other, the heat sources are separated, and thus, heat dissipation from the housing to the outside can be efficiently performed.

[Sixth Modification]

<Outline>

According to a sixth modification, the housing is sealed, the light-emitting module is mounted inside the sealed housing, and the sealed housing is filled with an inert gas.

<Configuration>

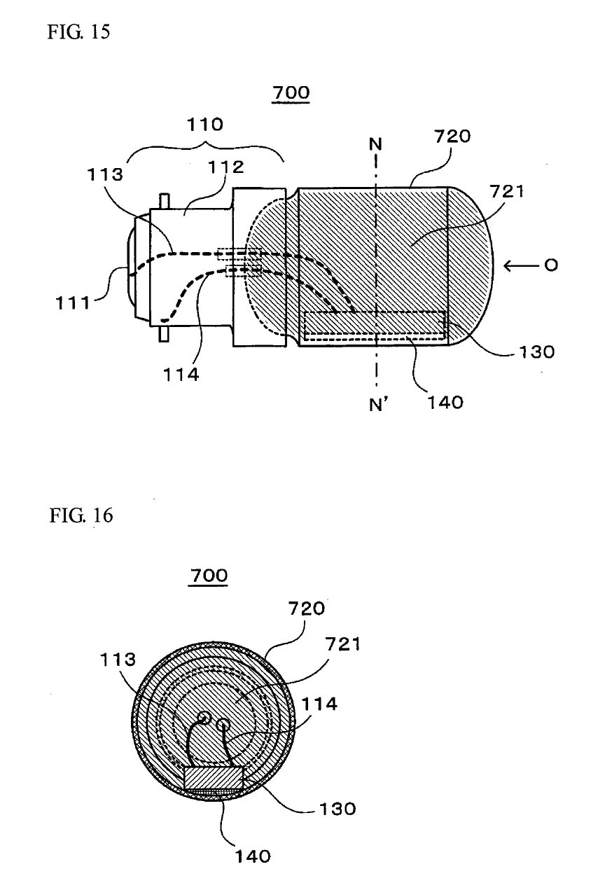

FIG. 15 shows a lamp 700 designed to use a solid-state light emitting device as a light source, according to the sixth modification, viewed in a lateral direction. FIG. 16 shows a cross section of the lamp 700 cut along chain line N-N′ in FIG. 15, viewed from a direction O in FIG. 15.

As shown in FIGS. 15 and 16, the lamp 700 according to the sixth modification includes the cap 110, a housing 720, and the light-emitting module 130. The gap between the housing 720 and the light-emitting module 130 is filled with the thermal conductive material 140. Further, the housing 720 is sealed, and filled with an inert gas 721. Here, in FIG. 15, the portion which is filled with the inert gas 721 is hatched for the convenience sake.

It should be noted that in FIGS. 15 and 16, components having similar functions to those of the components of the lamp 100 according to the first embodiment are denoted by the same reference numerals as those of the components of the lamp 100.

The housing 720 is a transparent case formed of a translucent material and is sealed, with the light-emitting module 130 mounted therein, and the sealed side of the housing 720 is connected to the cap 110. The lead wires 113 and 114 electrically connect the inside and the outside of the housing 720 so as to allow an electric power to be supplied to the light-emitting module 130 that is inside the housing 720. Further, the housing 720 is filled with an inert gas such as nitrogen gas. In this modification, the housing 720 has a substantially columnar shape whose body portion has a substantially cylindrical shape. The lower base of the substantially columnar shape is formed as the sealed portion, and the upper base has a slightly swelled dome shape.

Here, the light-emitting module 130 is mounted such that the main-light-emission side (lower side in FIGS. 15 and 16) thereof is in close contact with the inner wall of the housing 720, and the detailed relationship therebetween is similar to the relationship between the housing 120 and the light-emitting module 130 in the lamp 100 according to the first embodiment.

As described above, by the light-emitting module 130 being mounted and sealed in the housing 720, and by the housing 720 being filled with the inert gas 721, the durability and the reliability of the light-emitting module 130 can be greatly improved.

[Seventh Modification]

<Outline>

According to a seventh modification, the light-emitting module is pressed against the inner wall of the housing by means of an elastic body, thereby maintaining the degree of closeness of the contact between the light-emitting module and the housing. In a case where a plurality of light-emitting modules are mounted in the housing, the elastic body concurrently presses the plurality of light-emitting modules against the inner wall of the housing.

<Configuration>

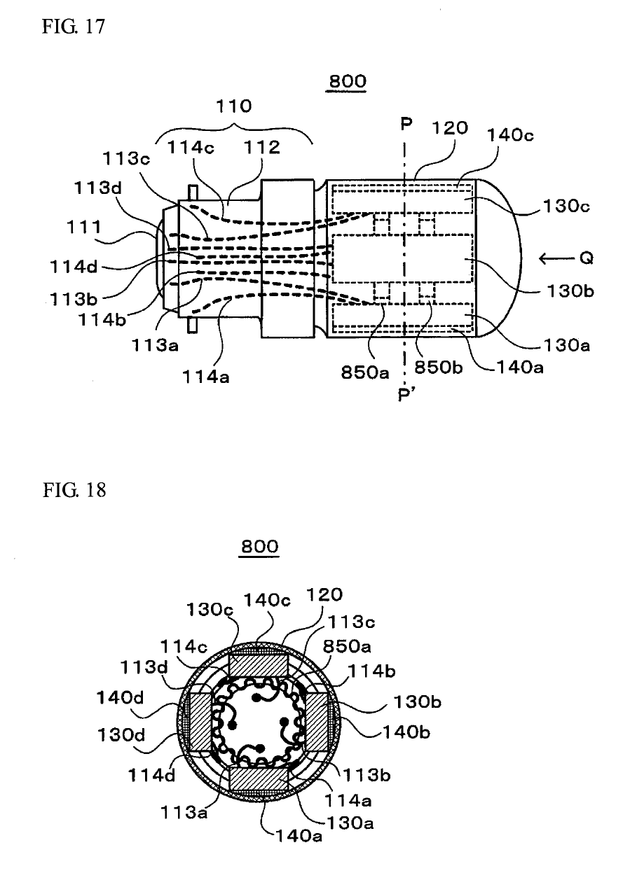

FIG. 17 shows a lamp 800 designed to use a solid-state light emitting device as a light source, according to the seventh modification, viewed in a lateral direction. FIG. 18 shows a cross section of the lamp 800 cut along chain line P-P′ in FIG. 17, viewed from a direction Q in FIG. 17.

As shown in FIGS. 17 and 18, the lamp 800 according to the seventh modification includes the cap 110, the housing 120, light-emitting modules 130a to 130d, and the gaps between the housing 120 and the light-emitting modules 130a to 130d are filled with thermal conductive materials 140a to 140d, respectively. The lamp 800 further includes elastic bodies 850a and 850b in the housing 120.

It should be noted that in FIGS. 17 and 18, components having similar functions to those of the components of the lamp 100 according to the first embodiment are denoted by the same reference numerals as those of the components of the lamp 100.

Lead wires 113a to 113d each have a similar function to that of the lead wire 113 according to the first embodiment, and lead wires 114a to 114d each have a similar function to that of the lead wire 114 according to the first embodiment.

Each of the light-emitting modules 130a to 130d has a similar function to that of the light-emitting module 130 according to the first embodiment.

Here, the electrodes 111 and 112 are each connected to the light-emitting module 130a via the lead wires 113a and 114a, to the light-emitting module 130b via the lead wires 113b and 114b, to the light-emitting module 130c via the lead wires 113c and 114c, and to the light-emitting module 130d via the lead wires 113d and 114d.

Each of the thermal conductive materials 140a to 140d has a similar function to that of the thermal conductive material 140 according to the first embodiment.

Here, the light-emitting modules 130a to 130d are mounted such that the main-light-emission sides (lower side in FIGS. 17 and 18) thereof, respectively, are in close contact with the inner wall of the housing 120. The detailed relationship therebetween is similar to the relationship between the housing 120 and the light-emitting module 130 in the lamp 100 according to the first embodiment.

Further, the thermal conductive material 140a fills the gap between the housing 120 and the light-emitting module 130a, the thermal conductive material 140b fills the gap between the housing 120 and the light-emitting module 130b, the thermal conductive material 140c fills the gap between the housing 120 and the light-emitting module 130c, and the thermal conductive material 140d fills the gap between the housing 120 and the light-emitting module 130d.

Each of the elastic bodies 850a and 850b is a ring-shaped spring, rubber, or the like that has an elastic force. The rear sides of the main-light-emission sides of the light-emitting modules 130a to 130d are pressed toward their corresponding main-light-emission sides, respectively, such that the main-light-emission sides of the light-emitting modules 130a to 130d are pressed against the inner wall of the housing 120.

It should be noted that, in this modification, the elastic bodies 850a and 850b concurrently press the four light-emitting modules toward their respective main-light-emission sides. However, irrespective of the number of the light-emitting modules, this modification can be applied. For example, in a case where the number of the light-emitting module is one, one light-emitting module is pressed toward its main-light-emission side.

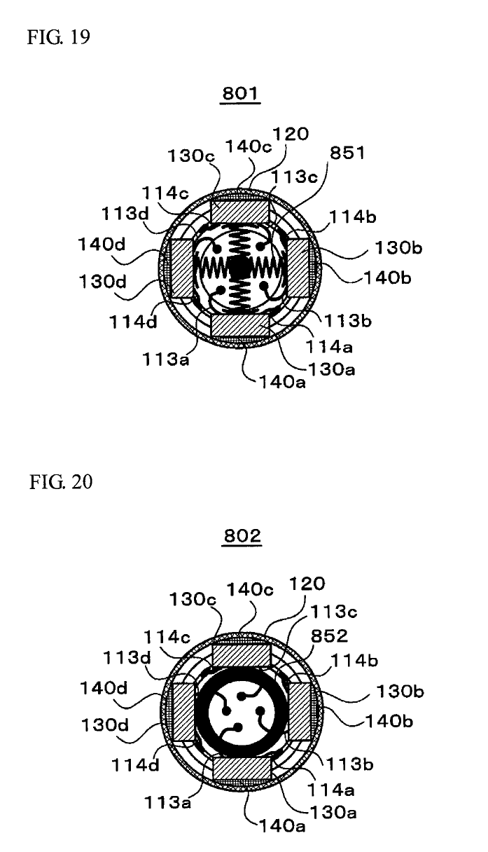

FIG. 19 shows a lamp 801 in which the elastic bodies 850a and 850b are replaced with another elastic body, and is a cross section corresponding to that in FIG. 18.

As shown in FIG. 19, the lamp 801 includes an elastic body 851 instead of the elastic bodies 850a and 850b of the lamp 800.

The elastic body 851 is a fitting for attaching light-emitting modules. The fitting is formed of a metal of a resin, and is composed of springs crossing each other and having an elastic force. The elastic body 851 presses the rear sides of the main-light-emission sides of the light-emitting modules 130a to 130d, toward their respective main-light-emission sides.

As described above, by pressing the light-emitting modules 130a to 130d against the inner wall of the housing 120 by means of the elastic bodies 850a and 850b or the elastic body 851, it is possible to maintain the degree of closeness of the contact between the light-emitting modules 130a to 130d and the housing 120, with a simple and inexpensive structure.

[Eighth Modification]

<Outline>

According to an eighth modification, the elastic bodies 850a and 850b according to the seventh modification are replaced with an elastic body having a good thermal conductivity, thereby thermally bonding the light-emitting modules.

<Configuration>

FIG. 20 shows an example in which the elastic bodies 850a and 850b are replaced with an elastic body having a good thermal conductivity, and is a cross section corresponding to that in FIG. 18.

As shown in FIG. 20, a lamp 802 according to the eighth modification includes an elastic body 852 instead of the elastic body 850a and 850b of the lamp 800.

It should be noted that in FIG. 20, components having similar functions to those of the components of the lamp 100 according to the first embodiment and those of the components of the lamp 800 according to the seventh modification are denoted by the same reference numerals as those of their corresponding components.

The elastic body 852 is a ring-shaped spring, rubber, or the like that has an elastic force, and has an enhanced thermal conductivity as a result of abundant use of a metal such as aluminium or an increased volume of the metal.

In this modification, the elastic body 852 concurrently presses four light-emitting modules toward their respective main-light-emission sides, and in addition, the four light-emitting modules are thermally bonded. However, as long as the number of the light-emitting modules is two or more, this modification can be applied.

As described above, by the elastic body 852 thermally bonding the light-emitting modules 130a to 130d, the variation in temperatures among the light-emitting modules can be reduced, and the variation in colors of emitted light can be suppressed.

[Ninth Modification]

<Outline>

A ninth modification shows an example in which a linear, double-ended-type lamp is used.

<Configuration>

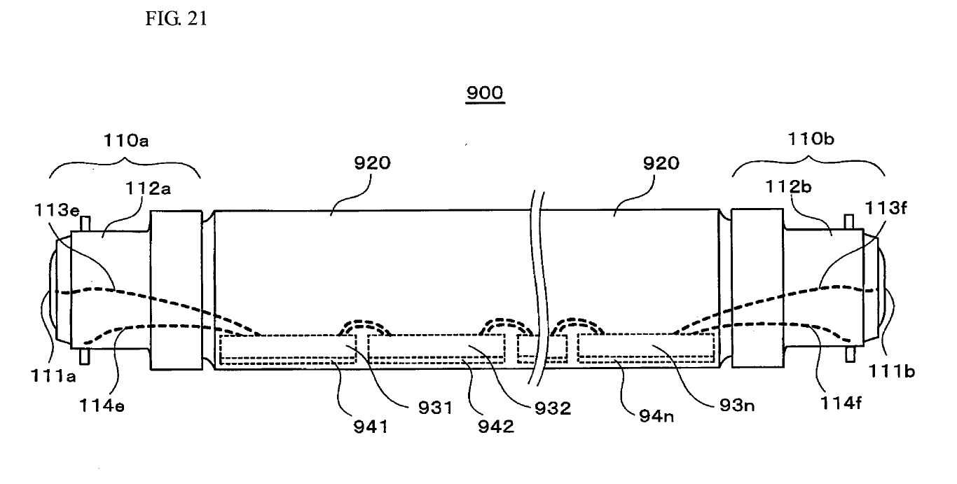

FIG. 21 shows a lamp 900 designed to use a solid-state light emitting device as a light source, according to the ninth modification, viewed in a lateral direction.

As shown in FIG. 21, the lamp 900 according to the ninth modification includes caps 110a and 110b, the housing 320, and n light-emitting modules 931, 932, . . . , and 93n. The gaps between the housing 920 and the n light-emitting modules 931, 932, . . . , and 93n are each filled with n thermal conductive materials 941, 942, . . . , and 94n, respectively. Here, n is an integer greater than or equal to 2.

Each of the caps 110a and 110b is formed of a structure material such as metal or resin, and is a portion to be attached to an external apparatus at the time of use. The caps 110a and 110b include electrodes 111a and 111b, 112a and 112b, and lead wires 113e and 113f, 114e and 114f, respectively. The electrodes 111a and 111b, and 112a and 112b are each made of a conductive substance such as a metal, and the two kinds of electrodes have to be insulated from each other. The electrodes 111a and 112a are connected to a light-emitting module 931 via the lead wires 113e and 114e, respectively, the electrodes 111b and 112b are connected to a light-emitting module 93n via the lead wires 113f and 114f, respectively, and are supplied with electric power. Adjacent light-emitting modules are connected to each other via connecting lead wires.

The housing 920 is a transparent case formed of a translucent material as in the housing 120 according to the first embodiment, and two opening portions thereof are connected to the caps 110a and 110b, respectively. In the ninth modification, the housing 920 has a substantially columnar shape whose body portion has a substantially cylindrical shape. The upper base and the lower base of the substantially columnar shape are formed as opening portions, respectively.

Here, the light-emitting modules 931, 932, . . . , and 93n are mounted such that the main-light-emission sides (lower side in FIG. 21) thereof are in close contact with the inner wall of the housing 920. The detailed relationship therebetween is similar to the relationship between the housing 120 and the light-emitting module 130 in the lamp 100 according to the first embodiment.

<Summary>

As described above, in each of the lamps according to the first embodiment and the first to ninth modifications, which are designed to use the solid-state light emitting devices as the light sources, respectively, the corresponding light-emitting module(s) are mounted such that the main-light-emission side(s) thereof are in close contact with the inner wall of the housing. Therefore, it is possible to release heat generated due to the light-emitting module(s) into the housing and then to dissipate the heat from the surface of the housing to the outside, without a particular provision of a heat sink, a fan, and the like for the heat dissipation.

Therefore, according to the above configurations, it is possible to improve the heat dissipation performance with a simple and inexpensive structure. Accordingly, without using a metal heat dissipation member, it is possible to obtain a heat dissipation characteristic necessary to ensure the light emission efficiency and the lifetime characteristic.

### Second Embodiment

<Outline>

According to a second embodiment, a light-emitting module is mounted such that the main-light-emission side thereof is in close contact with the main surface of a flat plate made of a translucent material, whereby heat generated due to the light-emitting module is released to the flat plate and dissipated from the surface of the flat plate to the outside.

<Configuration>

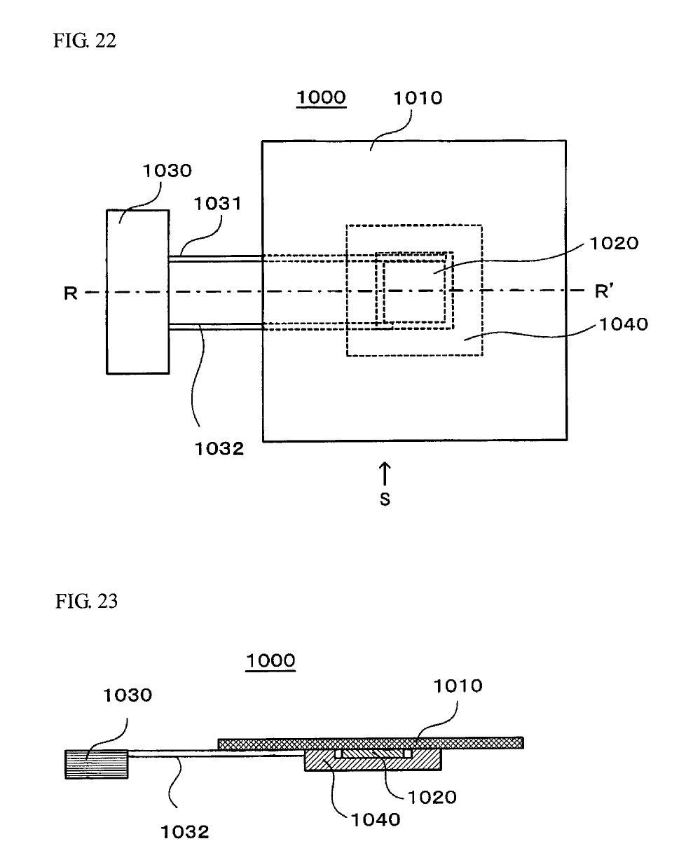

FIG. 22 shows a lamp 1000 designed to use a solid-state light emitting device as a light source, according to the second embodiment, viewed from a direction of a light emission surface. FIG. 23 shows a cross section of the lamp 1000 cut along chain line R-R′ in FIG. 22, viewed in a lateral direction S in FIG. 22.

As shown in FIGS. 22 and 23, the lamp 1000 according to the second embodiment includes a flat plate 1010, a light-emitting module 1020, a drive circuit 1030, and a heat sink 1040.

It should be noted that although this embodiment is directed to a lamp of a type including a drive circuit, a lamp of a type that does not include a drive circuit may be used.

The flat plate 1010 is a translucent plate having a flat plate shape formed of a translucent material, and is directly attached to a lighting apparatus as a front panel of the lighting apparatus when the lamp 1000 is used.

The light-emitting module 1020 is composed of one or a plurality of solid-state light emitting devices, and is mounted such that the main-light-emission side (upper side in FIG. 23) thereof is in close contact with a rear surface (lower surface in FIG. 23) of a surface which is to be used as the light emission surface of the flat plate 1010. Moreover, the light-emitting module 1020 has a function similar to that of the light-emitting module 130 according to the first embodiment, and the light-emitting module 1020 and the light-emitting module 130 are different from each other only in shape. In this embodiment, the light emission surface of the light-emitting module 1020 has a square plate shape.

The drive circuit 1030 is, as in the drive circuit 650 described in the fifth modification, an electronic circuit that outputs an electric power appropriate for lighting the light-emitting module 1020 and to drive and cause the solid-state light emitting device to emit light. The drive circuit 1030 includes lead wires 1031 and 1032 and is mounted at a position at which the drive circuit 1030 does not overlap the flat plate 1010 when viewed from the direction of the light emission surface.

The heat sink 1040 fixes the flat plate 1010 and the light-emitting module 1020 by means of an adhesive agent having a thermal conductivity, and concurrently, absorbs heat generated due to the light-emitting module 1020 and dissipates the heat into the air.

Here, the light-emitting module 1020 is mounted such that the main-light-emission side (lower side in FIG. 23) thereof is in close contact with, substantially at the center of, the rear surface of the flat plate 1010. Since the shape of the main-light-emission side of the light-emitting module 1020 and the shape of the rear surface of the flat plate 1010 are both flat, they can substantially be in close contact with each other without placing the thermal conductive material 140 therebetween as in the first embodiment. If a filling material that has a translucency and a thermal conductivity as the thermal conductive material 140 is placed between the main-light-emission side of the light-emitting module 1020 and the rear surface of the flat plate 1010, they can be in close contact with each other in a more assured manner, whereby improvement of the thermal conductivity can be expected.

It should be noted that, in the lamp 1000, use of the drive circuit 1030 and the heat sink 1040 is not necessarily required, and also in a case where these components are not provided, the object of the present invention can be attained.

[Tenth Modification]

<Outline>

A tenth modification has a configuration of the lamp 1000 according to the second embodiment from which the flat plate 1010 is removed, and is to be used by being attached to a panel made of a translucent material included in an appropriate external apparatus.

<Configuration>

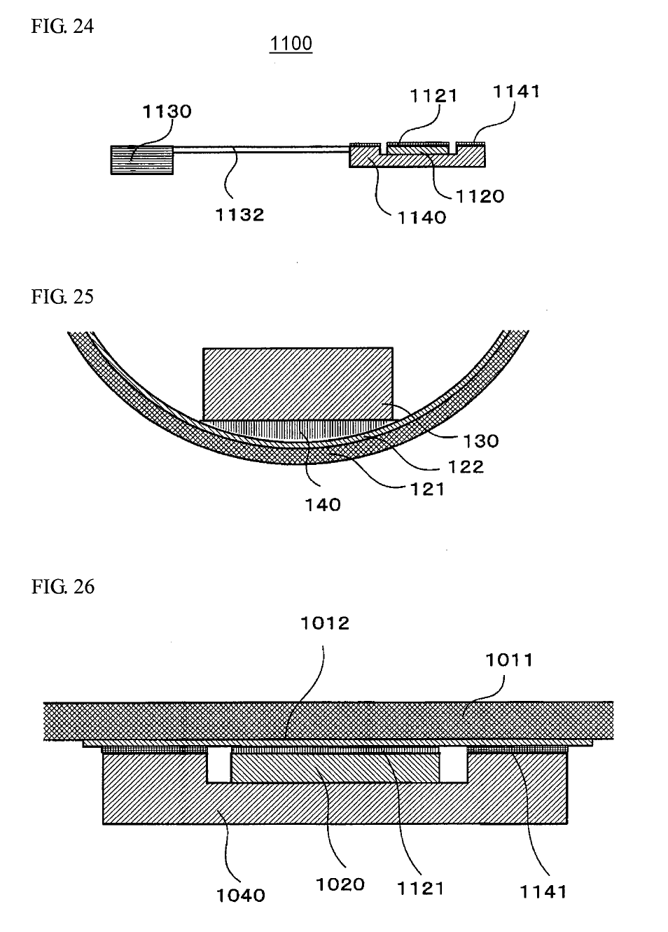

FIG. 24 shows a cross section of a lamp 1100 according to the tenth modification, viewed in a lateral direction, the cross section corresponding to that in FIG. 23.

As shown in FIG. 24, the lamp 1100 according to the tenth modification includes a light-emitting module 1120, a drive circuit 1130, and a heat sink 1140. It should be noted that in FIG. 24, components having similar functions to those of the components of the lamp 1000 according to the second embodiment are denoted by the same reference numerals as those of the components of the lamp 1000.

The light-emitting module 1120 is composed of one or a plurality of solid-state light emitting devices, and is fixed to the heat sink 1140 such that, when the heat sink 1140 is attached to a panel of an external apparatus, the main-light-emission side (upper side in FIG. 24) of the light-emitting module 1120 is in close contact with the panel. Moreover, a thermal conductive material 1121 having a translucency and a thermal conductivity is applied on the main-light-emission side of the light-emitting module 1120, and when the light-emitting module 1120 is attached to a panel of an external apparatus, the gap between the panel and the light-emitting module 1120 is filled with the thermal conductive material 1121.

The drive circuit 1130 is, as in the drive circuit 650 described in the fifth modification, an electronic circuit that outputs an electric power appropriate for lighting the light-emitting module 1120 and to drive and cause the solid-state light emitting device to emit light. The drive circuit 1130 includes lead wires 1131 and 1132, and is mounted at a distanced position such that, when the heat sink 1140 is attached to a panel of an external apparatus of a general size, the drive circuit 1130 cannot be seen through the panel.

The heat sink 1140 fixes the light-emitting module 1120 by means of an adhesive agent, or the like having a thermal conductivity, and concurrently, absorbs heat generated due to the light-emitting module 1120 and dissipates the heat into the air. Further, in this embodiment, an adhesive agent 1141 having a thermal conductivity is attached to the part of the heat sink 1140 that is to be attached to the panel of the external apparatus. Therefore, both can be in close contact with each other in a more assured manner, whereby improvement of the thermal conductivity can be expected.

It should be noted that in the lamp 1100, use of the drive circuit 1130 is not necessarily required, and also in a case where these components are not provided, the object of the present invention can be attained.

<Summary>

As described above, in each of the lamps according to the second embodiment and the tenth modification which are designed to use the solid-state light emitting devices as the light sources, respectively, the corresponding light-emitting module is mounted such that the main-light-emission side thereof is in close contact with a flat plate. Therefore, it is possible to release heat generated due to the light-emitting module into the flat plate and then to dissipate the heat from the surface of the flat plate to the outside.

Therefore, according to the above configurations, it is possible to improve the heat dissipation performance, with a simple and inexpensive structure.

[Eleventh Modification]

<Outline>

According to an eleventh modification, a light-emitting module is mounted such that the main-light-emission side thereof is in close contact with the inner surface of the housing made of a translucent material or a main surface of a flat plate, and at a position where the light-emitting module is mounted, a film of a wavelength conversion member is formed, thereby directly conveying heat generated from a phosphor film to the housing and the flat plate.

<Configuration>

FIG. 25 shows a film of a wavelength conversion member formed on the inner wall of the housing, around a position at which a light-emitting module is mounted, based on the lamp 100 according to the first embodiment. FIG. 25 corresponds to FIG. 3 according to the first embodiment, and shows an enlarged view of the portion where the light-emitting module is mounted. Here, FIG. 25 is different from FIG. 3 only in that, in FIG. 25, a film 122 of a wavelength conversion member is formed at a position where the light-emitting module is mounted in a housing body 121.

FIG. 26 shows a film of a wavelength conversion member formed on a flat plate around a position at which a light-emitting module is mounted, based on the lamp 1000 according to the second embodiment.

FIG. 26 corresponds to FIG. 23 according to the second embodiment, and shows an enlarged view of the portion where the light-emitting module is mounted. Here, FIG. 26 is different from FIG. 23 only in that, in FIG. 26, a film 1012 of a wavelength conversion member is formed at a position where the light-emitting module is mounted on a flat plate body 1011.

By integrating the film of the wavelength conversion member into the housing or the flat plate in this manner, it is possible to efficiently dissipate from the housing or the flat plate the heat generated at the film of the wavelength conversion member at which a large amount of heat is discharged in general, whereby the heat dissipation efficiency can be increased.

With respect to the translucent material, the coefficient of thermal conductivity and the thermal radiation can be enhanced by use of a translucent hard brittle material such as glass, and the translucent material can be made difficult to be broken by use of a material using resins.

<Discussion of Effects>

Reasons why the heat dissipation is ensured by use of the housing formed of a translucent material will be described below.

For example, the coefficient of thermal conductivity of glass which is one of translucent materials is lower by 2 to 3 orders than that of metals, but greater by one order than that of resins.

The coefficients of thermal conductivity of major substances are as follows: aluminum 240, copper 400, iron 80, glass 1, acrylic resin 0.2, polycarbonate resin 0.2, epoxy resin 0.2, polystyrene resin 0.1 (all in units of [W/m·K]).

In the case of the present invention, since the housing accounts for the major part of the outer shape of the lamp, a large envelope volume can be ensured, and in the case of the housing made of glass, since the emissivity is about 1, a high heat dissipation characteristic can be ensured.

The thermal emissivities of major substances (proportion relative to 1 of black body radiation) are: glass 0.9, aluminum (non-oxidized surface) 0.2, and aluminum (oxidized surface) 0.4 (all in units of absolute number [−]).

Moreover, the coefficient of thermal conductivity of a ceramic, for example, which is one of the translucent materials is about equivalent to or less by one order than metals (aluminium nitride ceramics 150, alumina 20 (each in units of [W/m·K])), and the thermal emissivity is close to black body radiation (ceramics 0.9 (in unit of absolute number [−])).

Therefore, in the case of the present invention, if the housing is made of ceramics, since the emissivity thereof is higher than that of glass, a higher heat dissipation characteristic can be ensured.

### INDUSTRIAL APPLICABILITY

The lamp according to the present invention releases heat generated due to the light-emitting module into the housing, and then dissipates the heat from the surface of the housing to the outside, and thus, can be applied to any lighting apparatus such as household lights and outdoor lights. In particular, the lamp according to the present invention can improve the heat dissipation performance with a simple and inexpensive structure, and can prevent the light emission efficiency from being reduced or the life of the lamp from being shortened. Therefore, the lamp according to the present invention is highly reliable and highly valuable in industrial usage.

### DESCRIPTION OF THE REFERENCE CHARACTERS

100 lamp

110 cap

111, 112, 111a to b, 112a to b electrode

113, 114, 113a to f, 114a to f lead wire

120 housing

121 housing body

122 film

130, 130a to d light-emitting module

140, 140a to d thermal conductive material

200 lamp

220 housing

230 light-emitting module

300 lamp

320 housing

321 lens

400 lamp

450 reflector plate

500 lamp

510 cap

511, 512 electrode

513, 514 lead wire

520 housing

550 light distribution adjustment mechanism part

600 lamp

650 drive circuit

700 lamp

720 housing

721 inert gas

800, 801, 802 lamp

850a to b, 851, 852 elastic body

900 lamp

920 housing

931, 932, . . . , 93n light-emitting module

941, 942, . . . , 94n thermal conductive material

1000 lamp

1010 flat plate

1011 flat plate body

1012 film

1020 light-emitting module

1030 drive circuit

1040 heat sink

1100 lamp

1120 light-emitting module

1121 thermal conductive material

1130 drive circuit

1131, 1132 lead wire

1140 heat sink

1141 adhesive agent

1. A lamp designed to use a solid-state light emitting device as a light source, the lamp comprising:
a cap configured to be attached to an external apparatus at the time of use;
a housing made of a translucent material and connected to the cap; and
a light-emitting module including one or a plurality of solid-state light emitting devices and mounted such that a main-light-emission side of the light-emitting module is in close contact with an inner wall of the housing.

2. The lamp according to claim 1, wherein
a gap between the housing and the light-emitting module is filled with a thermal conductive material having a translucency and a thermal conductivity.

3. The lamp according to claim 2, wherein
a portion of a surface of the housing at which the light-emitting module is mounted is shaped as a curved surface,
the main-light-emission side of the light-emitting module is shaped as a flat surface, and
the thermal conductive material functions as a lens by filling the gap between the housing and the light-emitting module.

4. The lamp according to claim 1, wherein
a film of a wavelength conversion member is formed on at least the portion of the housing at which the light-emitting module is mounted.

5. The lamp according to claim 1, further comprising:
a reflector plate in a space in the housing, at a rear side of the main-light-emission side of the light-emitting module.

6. The lamp according to claim 1, further comprising:
an elastic body in the housing, the elastic body pressing a rear side of the main-light-emission side of the light-emitting module toward the main-light-emission side such that the main-light-emission side of the light-emitting module is pressed against the inner wall of the housing.

7. The lamp according to claim 6, wherein
the lamp includes a plurality of the light-emitting modules,
the elastic body concurrently presses the plurality of the light-emitting modules toward the respective main-light-emission sides.

8. The lamp according to claim 7, wherein
the elastic body is mounted so as to be in close contact with rear sides of the respective plurality of the light-emitting modules, and thermally bonds the plurality of the light-emitting modules.

9. The lamp according to claim 1, wherein
the housing is sealed, includes the light-emitting module mounted inside the sealed housing, and is filled with an inert gas.

10. The lamp according to claim 1, further comprising:
a drive circuit mounted so as to be in close contact with the inner wall of the housing, operable to drive and cause the one or the plurality of solid-state light emitting devices to emit light, wherein
the housing includes a portion of a substantially cylindrical shape, and
the light-emitting module and the drive circuit are mounted at opposing positions, respectively, in an inner periphery of the portion of the substantially cylindrical shape.

11. A lamp module designed to use a solid-state light emitting device as a light source, the lamp module comprising:
a flat plate made of a translucent material having a flat plate shape, the flat plate configured to be, as a front panel of a lighting apparatus, directly attached to the lighting apparatus at the time of use; and
a light-emitting module including one or a plurality of solid-state light emitting devices, and mounted such that a main-light-emission side of the light-emitting module is in close contact with a rear surface of a surface which is to be used as a light emission surface of the flat plate.

12. The lamp module according to claim 11, wherein
a gap between the flat plate and the light-emitting module is filled with a thermal conductive material having a translucency and a thermal conductivity.

13. The lamp module according to claim 11, wherein
a film of a wavelength conversion member is formed on a portion, of the flat plate, at which the light-emitting module is mounted.

14. A lamp module designed to use a solid-state light emitting device as a light source, the lamp module comprising:
a heat sink having a thermal conductivity to be attached to a rear surface of a surface, of a panel made of a translucent material included in an external apparatus, to be used as a light emission surface; and
a light-emitting module including one or a plurality of solid-state light emitting devices, and fixed to the heat sink such that, when the heat sink is attached to the panel, a main-light-emission side of the light-emitting module is in close contact with the panel.

15. The lamp module according to claim 14, wherein
a thermal conductive material having a translucency and a thermal conductivity is placed on a surface of the main-light-emission side of the light-emitting module.

16. The lamp module according to claim 15, further comprising:
an adhesive agent having a thermal conductivity at a portion of the heat sink to be attached to the panel.

17. The lamp according to claim 14, further comprising:
a drive circuit configured to drive and cause the one or the plurality of solid-state light emitting devices to emit light, and mounted at a position where, when the heat sink is attached to the panel, the drive circuit is not seen through the panel.
